(19) United States
(12) Patent Application Publication
(10) Pub. No.: US 2024/0338738 A1
(43) Pub. Date: Oct. 10, 2024

(54) STORE APPLICATION CONTROL DEVICE, STORE APPLICATION CONTROL METHOD, AND STORE APPLICATION CONTROL PROGRAM

(71) Applicants: DENTSU INC., Tokyo (JP); Supership Inc., Tokyo (JP)

(72) Inventors: Masashi MIYAMAE, Tokyo (JP); Hidekazu SHIBATA, Tokyo (JP); Shinsuke NAKAMURA, Tokyo (JP)

(73) Assignees: DENTSU INC., Tokyo (JP); Supership Inc., Tokyo (JP)

(21) Appl. No.: 18/574,159

(22) PCT Filed: Jun. 14, 2022
(86) PCT No.: PCT/JP2022/023766

§ 371 Date: Dec. 26, 2023

(30) Foreign Application Priority Data
Jul. 1, 2021 (JP) 2021-109853

(51) Int. Cl. G06Q 30/06

(52) U.S. Cl. CPC G06Q 30/06

(57) ABSTRACT

The present invention provides a store application control device, a store application control method, and a store application control program that enable use of a flexible and convenient store application. A store application control device according to an aspect of the present disclosure includes: a store visit detecting unit that detects a store visit of a user on the basis of an action of the user; and an in-store mode activating unit that causes a terminal of the user to activate, among store applications having different operation aspects between an in-store mode and an out-of-store mode, the in-store mode when the store visit of the user is detected on the basis of the action of the user.

### TECHNICAL FIELD

The present disclosure relates to a store application control device, a store application control method, and a store application control program.

### BACKGROUND ART

Patent Literature 1 discloses a privilege granting management system and a privilege granting management method in which, in a system for distributing sales promotion information, a privilege is granted to a user in response to an event where the user having browsed the sales promotion information uses a store corresponding to the sales promotion information.

### CITATION LIST

### Patent Literature

Patent Literature 1: JP 2016-191978 A

### SUMMARY OF INVENTION

### Technical Problem

However, in Patent Literature 1, since the flow from the time when the user browses the sales promotion information to when the user uses the corresponding store and the privilege is granted to the user is complicated, there is room for improvement from the viewpoint of using a store application in a flexible and convenient way.

Thus, an object of the present disclosure is to provide a store application control device, a store application control method, and a store application control program that enable use of a store application in a flexible and convenient way.

### Solution to Problem

A store application control device according to an aspect of the present disclosure includes: a store visit detecting unit that detects a store visit of a user on the basis of an action of the user; and an in-store mode activating unit that causes a terminal of the user to activate, among store applications having different operation aspects between an in-store mode and an out-of-store mode, the in-store mode when the store visit of the user is detected on the basis of the action of the user.

The store application control device according to the aspect of the present disclosure includes: a store visit detecting unit that detects a store visit of a user on the basis of an active action of the user for notifying his/her store visit by bringing a terminal of the user close to perform near field communication (NFC); an in-store mode activating unit that activates, among store applications having different operation aspects between an in-store mode and an out-of-store mode, the in-store mode when the user's store visit is detected on the basis of the active action of the user; and a user information content outputting unit that outputs information of the user during activation of the in-store mode as content, in which the user information content outputting unit outputs a series of information including, as action data of the user in the in-store mode, information regarding detection of the user's store visit on the basis of the active action of bringing the terminal of the user close to perform the near field communication, information regarding an event log including a store visitor ID log, a store entry time log, a visit store log, a participation count log of a privilege related to the user's store use, a winning history log, a participation information log, and an advertisement ID log, information regarding an opt-in log including a beacon permission log and a location information permission log, information regarding an entry log including a sales promotion display log and a sales promotion participation log, information regarding an in-store travel log including a reception log for each shelf, and information regarding purchase of the user including use/non-use of the benefit.

### Advantageous Effects of Invention

According to the aspect of the present disclosure, it is possible to provide a store application control device, a store application control method, and a store application control program that enable use of a flexible and convenient store application.

### BRIEF DESCRIPTION OF DRAWINGS

FIG. 1 is a diagram illustrating an example of a schematic configuration of a store application control device according to an embodiment.

FIG. 2 is a diagram illustrating an example of an NFC tag installed at an entrance of a store.

FIG. 3 is a functional block diagram illustrating an example of an internal configuration of a server side device.

FIG. 4 is a conceptual diagram illustrating an example of a store application having an in-store mode and an out-of-store mode.

FIG. 5 is a diagram illustrating an example of a privilege regarding use of a store by a user that is provided upon activation of the in-store mode.

FIG. 6 is a diagram illustrating an example of different cases of behavior of a user terminal at the time of touch upon store entry.

FIG. 7 is a diagram illustrating an example of an operation of the store application during activation of the in-store mode.

FIG. 8 is a conceptual diagram illustrating an example of user information content output by a user information content outputting unit.

FIG. 9 is a conceptual diagram illustrating an example of utilization of acquired data in the in-store mode and the out-of-store mode.

FIG. 10 is a diagram illustrating an example of functional configurations of the user terminal and the server side device according to the embodiment.

FIG. 11 is a diagram illustrating an example of a hardware configuration of the user terminal, the server side device, and the like according to the embodiment.

### DESCRIPTION OF EMBODIMENTS

Hereinbelow, an embodiment of the present disclosure will be described in detail with reference to the accompanying drawings.

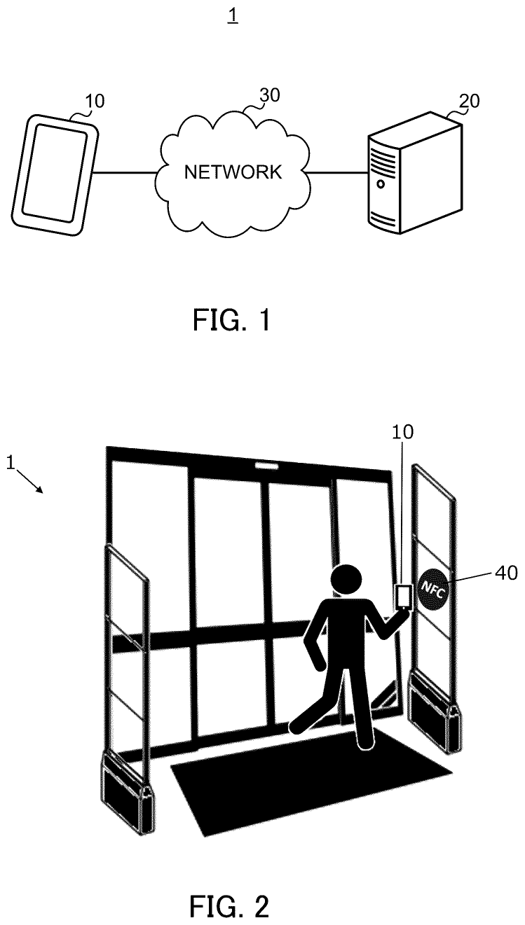

FIG. 1 is a diagram illustrating an example of a schematic configuration of a store application control device 1 according to the embodiment. The “store application control device” may be replaced with a “store application control system” (both may be synonymous). In addition, a store application control method and a store application control program according to the embodiment are realized by causing a computer (central processing unit (CPU)) included in the store application control device 1 to execute various processing steps.

As illustrated in FIG. 1, the store application control device 1 includes a user terminal 10, a server side device 20, and a network 30 that connects the user terminal 10 and the server side device 20. In FIG. 1, the user terminal 10 and the server side device 20 are each simply illustrated as a single configuration, but this is for convenience of drawing. In practice, both as a hardware configuration and a software configuration, the user terminal 10 and the server side device 20 have more complicated configurations than those illustrated in FIG. 1. Although details will be described later, for example, the server side device 20 may include multiple servers, databases, and the like.

The store application control device (store application control system) 1 may be regarded as a configuration including the user terminal 10 and the server side device 20, or may be regarded as a configuration including only the server side device 20 without including the user terminal 10. That is, in the store application control device 1, the user terminal 10 is not an essential component.

The user terminal 10 is, for example, a mobile terminal (mobile communication terminal) such as a mobile phone, a smartphone, or a tablet terminal. In other words, the user terminal 10 in the present specification is a communication device capable of performing various types of communication with the server side device 20. The user terminal 10 may communicate with a network (such as the Internet) via, for example, a wired and/or wireless communication (such as Long Term Evolution (LTE), 5^{th} Generation New Radio (5G NR), and Wi-Fi (registered trademark)). The user terminal 10 executes a browser and other various applications according to a user's operation.

The server side device 20 may be any communication device as long as it can perform various types of communication with the user terminal 10, and may be read as a device, a circuit, or the like. In particular, the server side device 20 performs various types of communication with the user terminal 10 in order to control execution of the store application in the user terminal 10 and collection and utilization of information related to this.

As illustrated in FIG. 2, the store application control device 1 includes a near field communication (NFC) tag 40 installed at an entrance (store front) of a store. The NFC tag 40 is a near field communication tag that does not require supply of power and has a degree of freedom in its installation location. The user terminal 10 has a near field communication function according to NFC. By bringing (placing) the user terminal 10 close to the NFC tag 40, near field communication between the user terminal 10 and the NFC tag 40 is performed, and the user's store visit is detected. In other words, the NFC tag 40 constitutes a “store visit detecting unit” that detects the user's store visit by near field communication (NFC) with the user terminal 10 on the basis of the user's action of bringing (placing) the user terminal 10 close to the NFC tag 40. The user's store visit detection information by the NFC tag (store visit detecting unit) 40 is transmitted to the server side device 20.

Note that, the action of the user is not limited to bringing (placing) the user terminal 10 close to the NFC tag 40. For example, it is preferable that the action is an action by the user to actively show his/her visit to the store, such as vibrating the user terminal 10 at a predetermined position. On the other hand, for example, passive detection of the user's store visit using a global positioning system (GPS) is not preferable from the viewpoint of protection of personal information.

Meanwhile, the method of the near field communication using the user terminal 10 is not limited to NFC, and other methods may be used. As described above, the “store visit detecting unit” may be any unit as long as it detects the user's store visit on the basis of the action of the user, has a degree of freedom in its specific aspects, and can be modified in design in various ways.

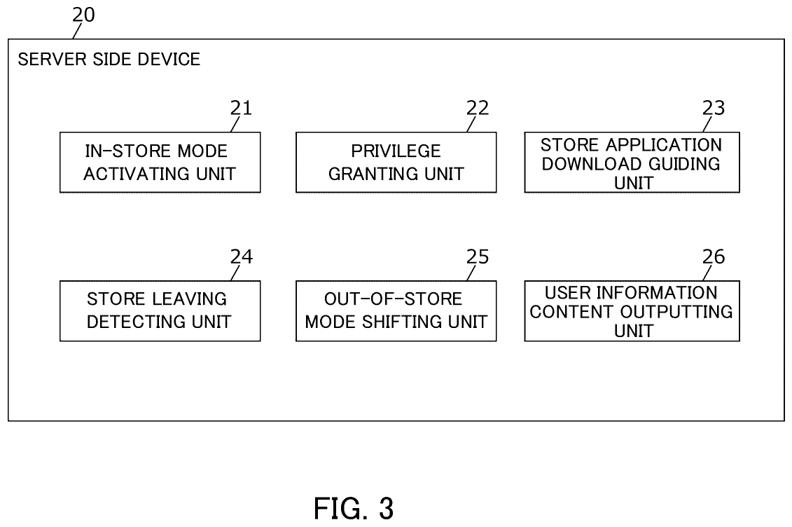

FIG. 3 is a functional block diagram illustrating an example of an internal configuration of the server side device 20.

As illustrated in FIG. 3, the server side device 20 includes an in-store mode activating unit 21, a privilege granting unit 22, a store application download guiding unit 23, a store leaving detecting unit 24, an out-of-store mode shifting unit 25, and a user information content outputting unit 26.

When the user's store visit is detected on the basis of the action of the user (when the near field communication between the user terminal 10 and the NFC tag 40 is detected), the in-store mode activating unit 21 causes the user terminal 10 to activate the in-store mode among the store applications having different operation aspects between the in-store mode and the out-of-store mode.

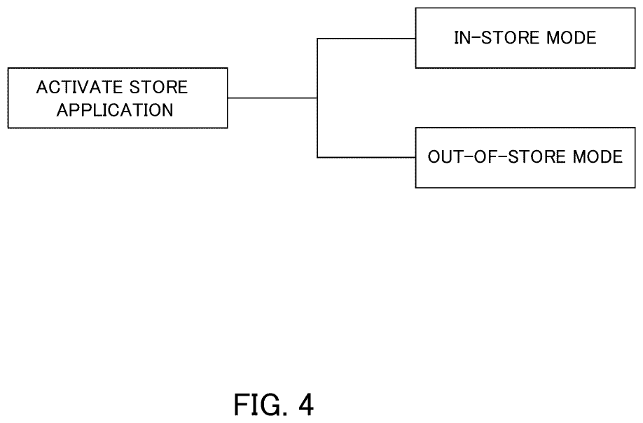

FIG. 4 is a conceptual diagram illustrating an example of the store application having the in-store mode and the out-of-store mode. In the present embodiment, when using the store application in the user terminal 10, either the in-store mode for providing a service specialized in the store, which can be used only in the store, or the out-of-store mode for using the application outside the store is selected. Whether the in-store mode or the out-of-store mode is selected is displayed on a display of the user terminal 10 when the store application is used (activated). In particular, when the in-store mode is displayed, it is preferable to create a characteristic frame on the display screen of the store application to produce the mood of visiting the store, and to display a pop-up window so as to notify the merit of the in-store mode.

On the assumption that the store application has been downloaded to the user terminal 10, when the user's store visit is detected on the basis of the user's action in the non-activated state of the store application (when the near field communication between the user terminal 10 and the NFC tag 40 is detected), the store application is activated in the in-store mode. Meanwhile, when the user's store visit is detected on the basis of the user's action in a state where the store application is activated in the out-of-store mode (when the near field communication between the user terminal 10 and the NFC tag 40 is detected), the store application is shifted from the out-of-store mode to the in-store mode.

The activation (transition) of the store application in (to) the in-store mode is executed as follows, for example. In response to an event where the user's store visit is detected on the basis of the user's action (the near field communication between the user terminal 10 and the NFC tag 40 is detected), guidance to the in-store mode such as PUSH notification or AppClip (up-clip) is displayed on the user terminal 10, and after tapping this guidance, the in-store mode is activated (shifted) upon the store visit action and permission of the in-store mode confirmation. Note that, activation of the store application in the out-of-store mode or shift from the in-store mode to the out-of-store mode which will be described later may be executed by a behavior similar to the above. The privilege granting unit 22 grants a privilege regarding use of the store by the user in response to the activation of the in-store mode of the store application by the in-store mode activating unit 21.

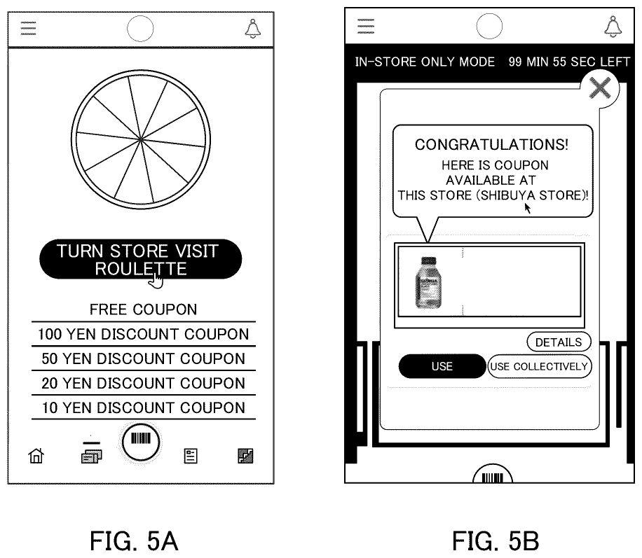

FIGS. 5A and 5B are diagrams illustrating an example of a privilege regarding use of the store by the user that is provided upon activation of the in-store mode. FIGS. 5A and 5B have a coupon granting mechanism by a store visit roulette as an example of a contrivance for habituating (inducing) the user to touch upon store entry (action of holding the user terminal 10 over the NFC tag 40). In the example of FIG. 5A, the store visit roulette is automatically turned in response to activation of the in-store mode, and any of a free coupon, a 100 yen discount coupon, a 50 yen discount coupon, a 20 yen discount coupon, and a 10 yen discount coupon is drawn. In the example of FIG. 5B, a 50 yen discount coupon of coffee as a specific product is drawn. Although the case where the target of the coupon is coffee as a specific product has been described here as an example, a product other than coffee may be the target, or a coupon targeting all products may be used. In addition, the content of the privilege is not limited to the store visit roulette, and may be a privilege of other aspects. In conjunction with touch upon store entry by the user (action of holding the user terminal 10 over the NFC tag 40), the store application is activated in the in-store mode, and the privilege regarding use of the store is granted integrally, so that the use of the store application in the in-store mode is promoted.

In a case where the user's store visit is detected on the basis of the action of the user (in a case where the near field communication between the user terminal 10 and the NFC tag 40 is detected), when the store application is not downloaded to the user terminal 10, the store application download guiding unit 23 guides the user terminal 10 to download the store application. Not all the user terminals 10 touching upon store entry (action of holding the user terminal 10 over the NFC tag 40) have downloaded the store application. Accordingly, for example, it is preferable to guide the user terminal 10 to download the store application by displaying a download screen of the store application on the display of the user terminal 10 or displaying a store of the store application.

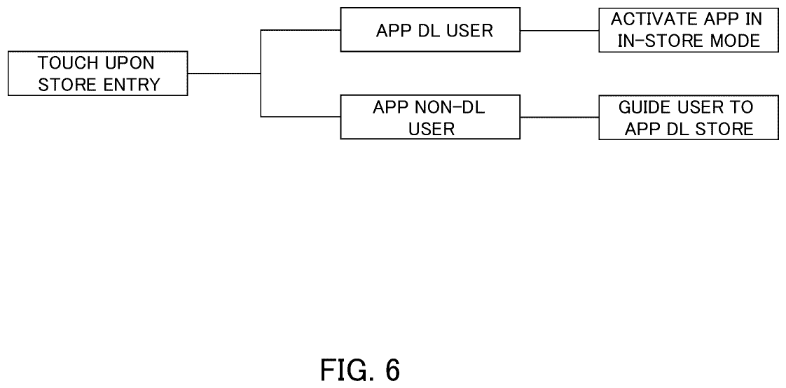

FIG. 6 is a diagram illustrating an example of different cases of behavior of the user terminal 10 at the time of touch upon store entry (action of holding the user terminal 10 over the NFC tag 40). As illustrated in FIG. 6, when touch upon store entry (action of holding the user terminal 10 over the NFC tag 40) is performed, it is determined whether or not the user is a DL user of the store application. In a case where the user is a DL user of the store application, for example, the store application is activated in the in-store mode after tapping via guidance such as PUSH notification or AppClip. As a result, it can be expected that the reuse of the store application by the dormant user is promoted and the activation of the store application is habituated. In a case where the user is a non-DL user of the store application, the user is guided to a DL store of the store application. Thereby, it can be expected to promote acquisition of new users downloading the store application.

The store leaving detecting unit 24 detects the user's leaving of the store. The out-of-store mode shifting unit 25 shifts the store application in the user terminal 10 from the in-store mode to the out-of-store mode when the user's leaving of the store is detected by the store leaving detecting unit 24. The store leaving detecting unit 24 can detect the user's leaving of the store, for example, by non-detection of in-store Wi-Fi (registered trademark) of the user terminal 10 and detection of movement from the coordinates at the time of store entry according to GPS data. In addition, the store leaving detecting unit 24 can detect the user's leaving of the store by mounting a delegate method (for example, didExitRegion) that causes an action triggered by the fact that the user terminal 10 is no longer able to be detected by a beacon mechanism. Alternatively, the store leaving detecting unit 24 may detect (presume) the user's leaving of the store when a predetermined time (for example, 30 minutes) has elapsed from the entry, automatically log out from the in-store mode, and shift to the out-of-store mode. As described above, there is a degree of freedom in how the store leaving detecting unit 24 detects the user's leaving of the store, and various design changes are possible.

The user information content outputting unit 26 outputs information of the user during activation of the in-store mode as content. The information of the user during the activation of the in-store mode includes, for example, travel information and purchase information in the store, use information of the privilege granted by the privilege granting unit 22, and the like.

More specifically, the user information content outputting unit 26 can output, as action data of the user in the in-store mode, a series of information regarding touch upon store entry, a store entry event (including granting of a privilege), an in-store mode display (opt-in confirmation), in-store sales promotion (linked with a beacon), a travel event (linked with a beacon), and purchase (IDPOS) as user information content. Further, the user information content outputting unit 26 can also output the user information content by adding action data of the user in the out-of-store mode, the personal information of the user, and other various kinds of information to the action data of the user in the in-store mode described above. The user information content output by the user information content outputting unit 26 will be described in more detail later.

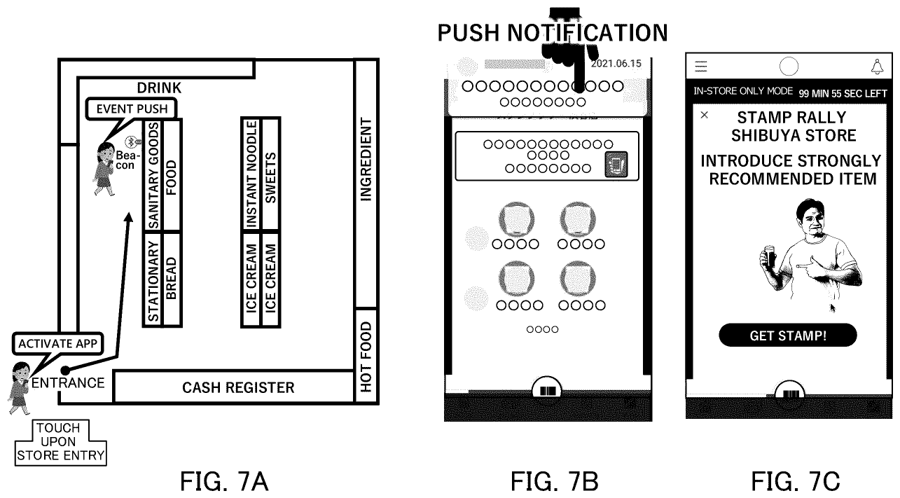

FIGS. 7A, 7B, and 7C are diagrams illustrating an example of an operation of the store application during the activation of the in-store mode. A store illustrated in FIG. 7A is a convenience store, a supermarket, a drug store, a home center, or the like in which products such as drinks, ingredients, hot foods, sweets, instant noodles, ice cream, food, bread, sanitary goods, and stationery are displayed and the user pays for an intended product at a cash register. However, FIG. 7A is merely an example, and there is a degree of freedom in the aspect of a store to which the store application is applied, and various design changes are possible.

As illustrated in FIG. 7A, a wireless sign transmitter such as a beacon, radio frequency identification (RFID), or Wi-Fi (registered trademark) is installed at a predetermined position in the store. In the example of FIG. 7A, a beacon is installed in the vicinity of the sanitary goods section. The wireless sign transmitter as described above transmits a wireless sign linked to the store application. For example, the wireless sign is for sending an event PUSH notification for issuing a coupon that can be used in purchasing a product in the store in a stamp format. During the activation of the in-store mode, when the user enters the display zone of a specific product (FIG. 7A), the user terminal 10 is notified of an event PUSH related to the specific product by using the reaction of the user terminal 10 to the wireless sign as a trigger (FIGS. 7B and 7C). There is a degree of freedom in the aspect of the event PUSH notification. For example, as illustrated in FIG. 7B, this notification can be configured in such a way that a message such as “Receive PUSH notifications near items! Collect stamps to receive special coupons” is displayed to prompt the user to receive the event PUSH notifications of multiple products, and when the user achieves this, a further privilege is granted to the user.

In this way, during the activation of the in-store mode, a notification (event PUSH notification) regarding the use of the store by the user is made to the user terminal 10 using the wireless sign linked with the store application as a trigger. The notification regarding the use of the store by the user may be in conjunction with sales promotion of a shelf product by the stamp rally described above or the like, or may be in conjunction with feedback collection regarding display or replacement of the shelf product by means of questionnaire format or the like.

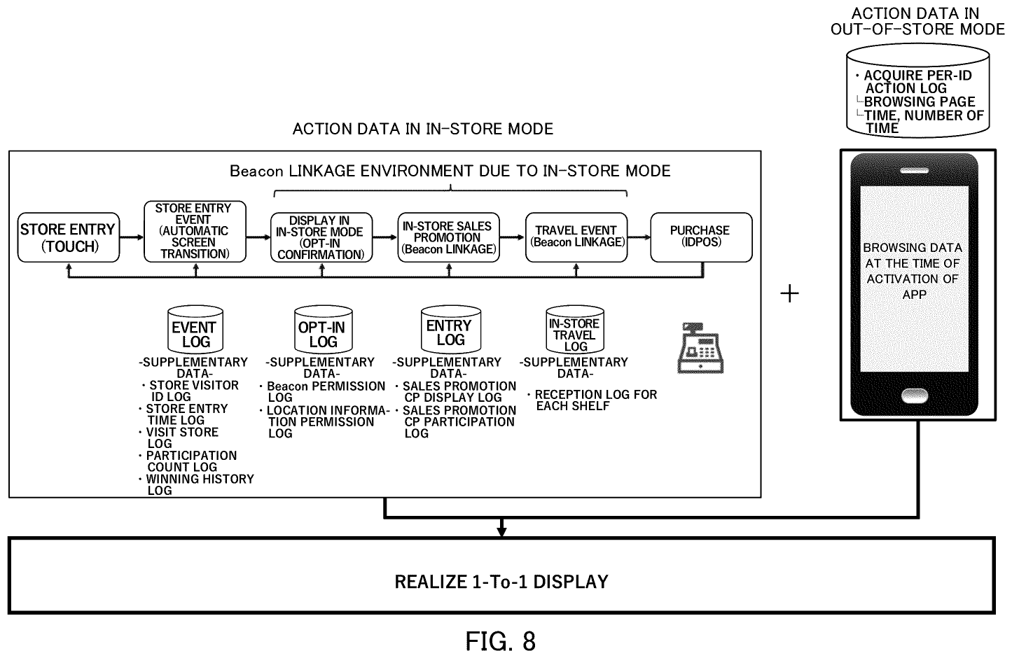

FIG. 8 is a conceptual diagram illustrating an example of user information content output by the user information content outputting unit 26.

The user information content can display, for example, the action data of the user in the in-store mode and the action data of the user in the out-of-store mode in a 1-to-1 manner.

The action data of the user in the in-store mode includes the following information. First, the near field communication between the user terminal 10 and the NFC tag 40 is detected at the time of store entry (touch), and an event log is acquired at the time of a subsequent store entry event (automatic screen transition). In this event log, a store visitor ID log, a store entry time log, a visit store log, and the like are acquired as the action data of the user. In addition, for example, as an event log at the time of the store visit roulette, a participation information log, an advertisement ID log, and the like are acquired as the action data of the user in addition to a participation count log and a winning history log. Next, at the time of display in the in-store mode (opt-in confirmation), a beacon permission log and a location information permission log are acquired as the action data of the user as opt-in logs. Subsequently, at the time of in-store sales promotion (beacon linkage), a sales promotion CP display log and a sales promotion CP participation log are acquired as the action data of the user as entry logs. Next, at the time of the travel event (beacon linkage), a reception log for each shelf is acquired as the action data of the user as in-store travel logs. Finally, actual purchase (IDPOS) data of the user (including use/non-use of coupons and the like) is acquired as the action data of the user. Each stage of the display in the in-store mode, the in-store sales promotion, and the travel event is executed in the beacon linkage environment in the in-store mode.

In this manner, in the in-store mode, it is possible to supplement data from the user's store entry to the user's leaving of the store to realize data marketing combining data acquisition logs. In other words, customer management by reverse calculation of the purchase data can be realized by associating an event flag, an in-store flag (opt-in flag), an entry flag, and a travel flag after store entry (touch) with the ID of each user (it is possible to smoothly cooperate with the cash register at the time of payment using the in-store mode). In other words, it is possible to use the action of the user and the payment data in conjunction with each other for analysis in units of IDs and marketing in units of IDs through management of the in-store action logs using one ID.

On the other hand, the action data of the user in the out-of-store mode can be obtained by utilizing the log data, the purchase data, the browsing data at the time of activation of the store application, and the like acquired in the in-store mode, and appropriately adding customization such as combination or editing. Specifically, the action data of the user in the out-of-store mode can be per-ID action log data including the browsing page, the browsing time, and the number of times of browsing of the store application.

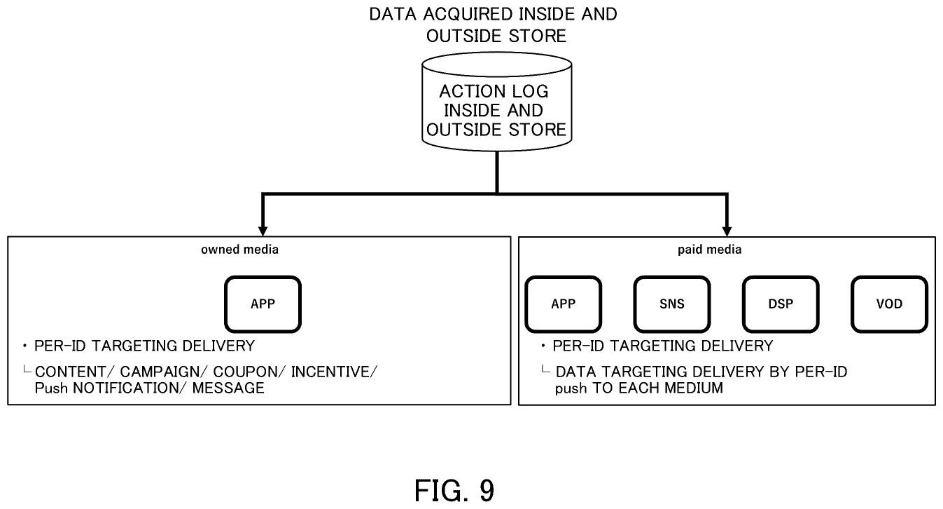

FIG. 9 is a conceptual diagram illustrating an example of utilization of acquired data (action log) in the in-store mode and the out-of-store mode. As illustrated in FIG. 9, the acquired data (action log) in the in-store mode and the out-of-store mode are subjected to per-ID targeting delivery as content/campaign/coupon/incentive/push notification/message in owned media (media owned by the company), for example. In addition, the acquired data (action log) in the in-store mode and the out-of-store mode are subjected to per-ID targeting delivery as data by IDpush to each medium in, for example, paid media (media posted by paying costs such as advertisement cost).

As described above, the store application control device 1 according to the present disclosure includes the NFC tag (store visit detecting unit) 40 that detects the user's store visit on the basis of the action of the user, and the in-store mode activating unit 21 that causes the user terminal 10 to activate the in-store mode among the store applications having different operation aspects between the in-store mode and the out-of-store mode when the user's store visit is detected on the basis of the action of the user. As a result, a store application can be used in a flexible and convenient way.

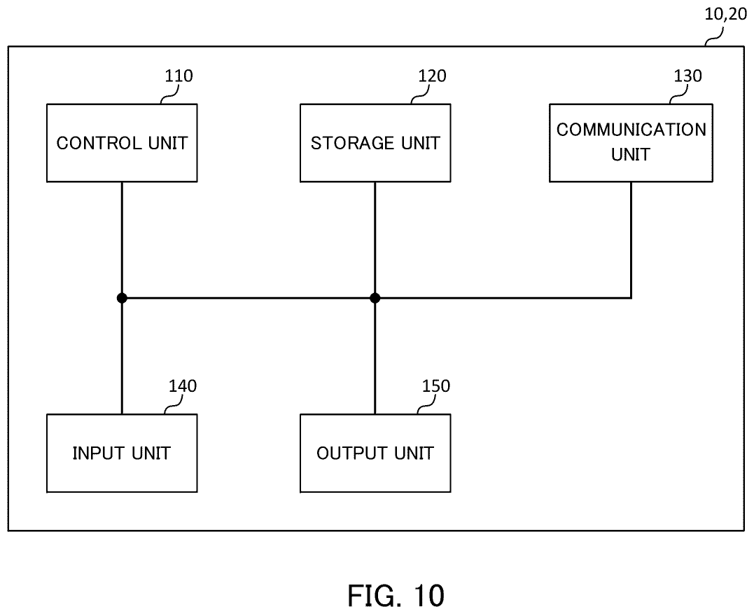

FIG. 10 is a diagram illustrating an example of functional configurations of the user terminal 10 and the server side device 20 according to the embodiment. As illustrated in FIG. 10, the user terminal 10 and the server side device 20 include a control unit 110, a storage unit 120, a communication unit 130, an input unit 140, and an output unit 150. Note that, FIG. 10 illustrates an example of functional blocks of the user terminal 10 and the server side device 20, and may include other functional blocks not illustrated in FIG. 10. In addition, a configuration not including a part of the functional blocks may be employed.

The control unit 110 controls the user terminal 10 and/or the server side device 20. The control unit 110 can be configured by a controller, a control circuit, or a control device described on the basis of common recognition in the technical field according to the present invention.

The storage unit 120 stores information used by the user terminal 10 and/or the server side device 20. The storage unit 120 can be configured by, for example, a memory, a storage, a storage device, and the like described on the basis of common recognition in the technical field according to the present invention.

The communication unit 130 performs communication (for example, mutual communication) between the user terminal 10 and/or the server side device 20. The communication unit 130 can be configured by a transmitter/receiver, a transmission/reception circuit, or a transmission/reception device described on the basis of common recognition in the technical field according to the present invention. Note that, the communication unit 130 may be configured by a transmission unit and a reception unit.

The input unit 140 receives an input in the user terminal 10 and/or the server side device 20. Further, the input unit 140 may be connected to a predetermined device, a storage medium, and the like and receive an input of data. The input unit 140 may output an input result to the control unit 110, for example. The input unit 140 can be configured by an input device such as a keyboard, a mouse, and a button, an input/output terminal, an input/output circuit, and the like described on the basis of common recognition in the technical field according to the present invention. Further, the input unit 140 may have a configuration integrated with a display unit (a touch panel, for example).

The output unit 150 performs output in the user terminal 10 and/or the server side device 20. For example, the output unit 150 may include a display unit that displays an image, a sound output unit that outputs sound, and the like. The display unit can be configured by, for example, a display device such as a display or a monitor described on the basis of common recognition in the technical field according to the present invention. Further, the sound output unit can be configured by an output device such as a speaker described on the basis of common recognition in the technical field according to the present invention.

Note that, the block diagram used in the description of the above embodiment illustrates blocks in units of functions. These functional blocks (components) are realized by any combination of hardware and/or software. In addition, means for realizing the functional blocks is not particularly limited. That is, the functional blocks may be realized by one physically coupled device, or may be realized by two or more physically separated devices which are connected by wire or wirelessly.

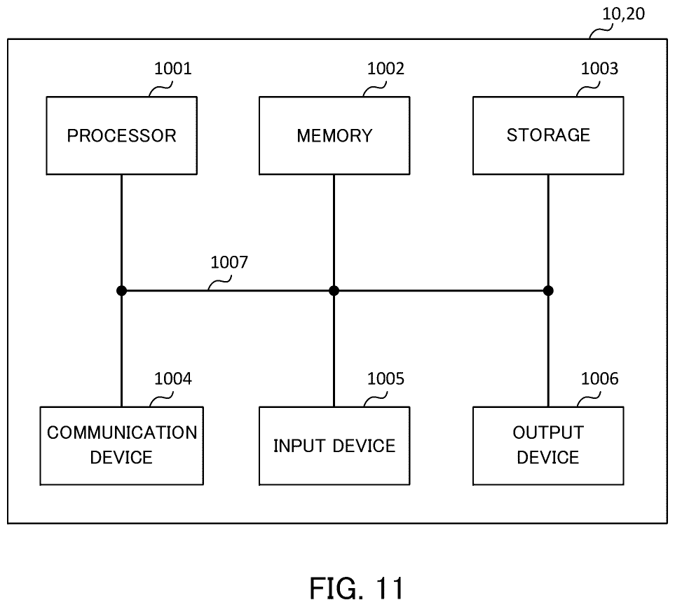

For example, the apparatus in the embodiment of the present disclosure (such as the user terminal 10 and the server side device 20) may function as a computer that performs processing of an application evaluation method of the present disclosure. FIG. 11 is a diagram illustrating an example of a hardware configuration of the user terminal 10, the server side device 20, and the like according to the embodiment. The user terminal 10, the server side device 20, and the like described above may be physically configured as a computer device including a processor 1001, a memory 1002, a storage 1003, a communication device 1004, an input device 1005, an output device 1006, a bus 1007, and the like.

Note that, in the present disclosure, the apparatus, the circuit, the device, the unit, the server, and the like can be replaced with each other. The hardware configuration of the user terminal 10, the server side device 20, and the like may be configured to include one or multiple devices illustrated in the drawings, or may be configured without including some devices.

For example, although only one processor 1001 is illustrated, there may be multiple processors. Further, the processing may be executed by one processor, or the processing may be executed by two or more processors simultaneously, sequentially, or using other methods. Note that, the processor 1001 may be implemented by one or more chips.

Each function in the user terminal 10, the server side device 20, and the like is realized by the processor 1001 performing operation by loading predetermined software (program) on hardware such as the processor 1001 and the memory 1002, and controlling communication by the communication device 1004, reading and/or writing of data from/to the memory 1002 and the storage 1003, and the like.

The processor 1001 operates, for example, an operating system to control the entire computer. The processor 1001 may be configured by a central processing unit (CPU) including an interface with a peripheral device, a control device, an operation device, a register, and the like. Note that, each unit such as the above-described control unit 110 may be realized by the processor 1001.

In addition, the processor 1001 reads a program (program code), a software module, data, and the like from at least one of the storage 1003 and the communication device 1004 to the memory 1002, and executes various processes according to them. As the program, a program that causes a computer to execute at least a part of the operations described in the above-described embodiment is used. For example, the control unit 110 may be realized by a control program stored in the memory 1002 and operated in the processor 1001, and other functional blocks may be realized in the same way.

The memory 1002 is a computer-readable recording medium, and may include, for example, at least one of a read only memory (ROM), an erasable programmable ROM (EPROM), an electrically EPROM (EEPROM), a random access memory (RAM), or another appropriate storage medium. The memory 1002 may be referred to as a register, a cache, a main memory (main storage device), or the like. The memory 1002 may store a program (program code), a software module, and the like that can be executed to implement the method according to the embodiment.

The storage 1003 is a computer-readable recording medium, and may be configured by, for example, at least one of a flexible disk, a floppy (registered trademark) disk, a magneto-optical disc (for example, a compact disc (such as a compact disc ROM (CD-ROM)), a digital versatile disc, or a Blu-ray (registered trademark) disc), a removable disc, a hard disc drive, a smart card, a flash memory device (for example, a card, a stick, or a key drive), a magnetic stripe, a database, a server, or another appropriate storage medium. The storage 1003 may be referred to as an auxiliary storage device. Note that, the above-described storage unit 120 may be realized by the memory 1002 and/or the storage 1003.

The communication device 1004 is hardware (transmission/reception device) for performing communication between computers via at least one of a wired network and a wireless network, and is also referred to as, for example, a network device, a network controller, a network card, a communication module, or the like. The communication device 1004 may include a SIM card. Note that, the above-described communication unit 130 may be realized by the communication device 1004.

The input device 1005 is an input device (such as a keyboard and a mouse) that receives an input from the outside. The output device 1006 is an output device (such as a display and a speaker) that performs output to the outside. Note that, the input device 1005 and the output device 1006 may have an integrated configuration (such as a touch panel). Note that, the input unit 140 and the output unit 150 described above may be realized by the input device 1005 and the output device 1006, respectively.

In addition, the devices such as the processor 1001 and the memory 1002 are connected by a bus 1008 for communicating information. The bus 1007 may be configured by a single bus or may be configured by different buses between devices.

Further, the user terminal 10, the server side device 20, and the like may include hardware such as a microprocessor, a digital signal processor (DSP), an application specific integrated circuit (ASIC), a programmable logic device (PLD), and a field programmable gate array (FPGA), and some or all of the functional blocks may be realized by the hardware. For example, the processor 1001 may be implemented by at least one of these pieces of hardware.

### Modified Example

Note that, the terms described in the present disclosure and/or terms necessary for understanding the present disclosure may be replaced with terms having the same or similar meanings.

The information, the parameter, and the like described in the present disclosure may be represented by using absolute values, may be represented by using relative values obtained from predetermined values, or may be represented by using another corresponding information. In addition, names used for parameters and the like in the present disclosure are not limited in any respect.

The information, signals, and the like described in the present disclosure may be represented by using any of a variety of different techniques. For example, data, instructions, commands, information, signals, bits, symbols, chips, and the like that may be mentioned throughout the above description may be represented by voltages, currents, electromagnetic waves, magnetic fields or magnetic particles, optical fields or photons, or any combination of them.

Information, signals, and the like may be input and output via multiple network nodes. The input/output information, signals, and the like may be stored in a specific location (such as a memory) or may be managed using a table. The input/output information, signals, and the like can be overwritten, updated, or added. The output information, signals, and the like may be deleted. The input information, signals, and the like may be transmitted to another device.

Further, notification of predetermined information (such as notification of “being X”) is not limited to explicit notification, and may be performed implicitly (for example, by not notifying the predetermined information or by notifying another information).

Software, irrespective of whether referred to as software, firmware, middleware, microcode, hardware description language, or other names, should be construed broadly to mean instructions, instruction sets, codes, code segments, program codes, programs, subprograms, software modules, applications, software applications, software packages, routines, subroutines, objects, executable files, execution threads, procedures, functions, and the like.

In addition, software, instructions, information, and the like may be transmitted and received via at least one of a transmission medium and a signal waveform. For example, when software is transmitted from a website, server, or other remote sources using at least one of a wired technique (such as a coaxial cable, an optical fiber cable, a twisted pair, and a digital subscriber line (DSL)) and a wireless technique (such as infrared rays and microwaves), at least one of these wired and wireless techniques is included within the definition of the transmission medium.

The terms “system” and “network” used in the present disclosure may be used interchangeably.

Each aspect/embodiment described in the present disclosure may be used alone, or may be used in combination, or may be switched during execution. In addition, the order of the processing procedure, sequence, flowchart, and the like of each aspect/embodiment described in the present disclosure may be changed as long as there is no contradiction. For example, in the method described in the present disclosure, elements of various steps are presented using an illustrative order, and their order is not limited to the particular order presented.

The phrase “on the basis of” used in the present disclosure does not mean “on the basis only of” unless explicitly stated otherwise. In other words, the description “on the basis of” means both “on the basis only of” and “on the basis at least of.”

Any reference to elements using designations such as “first,” “second,” and the like used in the present disclosure does not generally limit the amount or order of those elements. These designations may be used in the present disclosure as a convenient way to distinguish between two or more elements. Thus, reference to the first and second elements does not imply that only two elements may be employed or that the first element must in any way precede the second element.

In a case where the present disclosure uses the terms “include,” “including,” and their variations, these terms are intended to be inclusive in a manner similar to the term “comprising.” Further, the term “or” used in the present disclosure is intended not to be an exclusive OR.

In the present disclosure, for example, in a case where articles such as a, an, and the in English are added by translation, the present disclosure may include a case where a noun following these articles is a plural form.

Although the invention according to the present disclosure has been described in detail above, it is apparent to those skilled in the art that the invention according to the present disclosure is not limited to the embodiment described in the present disclosure. The invention according to the present disclosure can be implemented as modifications and variations without departing from the spirit and scope of the invention defined based on the description of the claims. Therefore, the description of the present disclosure is for the purpose of illustration and does not bring any restrictive meaning to the invention according to the present disclosure.

The present application is based on Japanese Patent Application No. 2021-109853 filed or. Jul. 1, 2021. All the contents shall be included here.

1. A store application control device comprising:
a store visit detecting unit that detects a store visit of a user on the basis of an action of the user; and
an in-store mode activating unit that causes a terminal of the user to activate, among store applications having different operation aspects between an in-store mode and an out-of-store mode, the in-store mode when the store visit of the user is detected on the basis of the action of the user.

2. The store application control device according to claim 1, further comprising
a privilege granting unit that grants a privilege regarding use of the store by the user in response to activation of the in-store mode.

3. The store application control device according to claim 1, further comprising
a user information content outputting unit that outputs information of the user during activation of the in-store mode as content.

4. The store application control device according to claim 1, further comprising
a store application download guiding unit that guides, in a case where the store visit of the user is detected on the basis of the action of the user, the terminal of the user to download the store application when the store application is not downloaded to the terminal of the user.

5. The store application control device according to claim 1, wherein,
during the activation of the in-store mode, a notification regarding the use of the store by the user is made to the terminal of the user using a wireless sign linked with the store application as a trigger.

6. The store application control device according to claim 1, further comprising:
a store leaving detecting unit that detects leaving of the store by the user; and
an out-of-store mode shifting unit that shifts the store application in the terminal of the user from the in-store mode to the out-of-store mode when the leaving of the store by the user is detected.

7. The store application control device according to claim 1, wherein
the store visit detecting unit detects the store visit of the user by near field communication (NFC) with the terminal of the user.

8. A store application control method comprising causing a computer to execute:
store visit detecting of detecting a store visit of a user on the basis of an action of the user; and
in-store mode activating of causing a terminal of the user to activate, among store applications having different operation aspects between an in-store mode and an out-of-store mode, the in-store mode when the store visit of the user is detected on the basis of the action of the user.

9. A computer-readable storage medium including a store application control program causing a computer to execute:
store visit detecting of detecting a store visit of a user on the basis of an action of the user; and
in-store mode activating of causing a terminal of the user to activate, among store applications having different operation aspects between an in-store mode and an out-of-store mode, the in-store mode when the store visit of the user is detected on the basis of the action of the user.
